(19) United States
(12) Patent Application Publication
(10) Pub. No.: US 2005/0216793 A1
(43) Pub. Date: Sep. 29, 2005

(54) Method and apparatus for detecting abnormal behavior of enterprise software applications

(76) Inventors: Gadi Entin, Hod Hasharon (IL); Smadar Nehab, Tel Aviv (IL); Ron Levkovitz, Ramat Gan (IL)

Correspondence Address: GLENN PATENT GROUP, 3475 EDISON WAY, SUITE L, MENLO PARK, CA, 94025, US

(21) Appl. No.: 11/093,569

(22) Filed: Mar. 29, 2005

Related U.S. Application Data
(60) Provisional application No. 60/556,902, filed on Mar. 29, 2004.

(51) Int. Cl. G06F 11/00; G06F 9/44

(52) U.S. Cl. 714/38; 717/124

(57) ABSTRACT

A method and apparatus for detecting abnormal behavior of enterprise software applications is disclosed. A profile that represents the behavior of the function is created for each service and error function integrated in an enterprise software application. This profile is based on input measurements, such as response time, throughput, and non-availability. For each such input measurement, the expected behavior is determined, as well as the upper and lower bounds on that expected behavior. The invention further monitors the behavior of service and error functions and produces an exception if at least one of the upper or lower bounds is violated. The detection scheme disclosed is dynamic, adaptive, and has self-learning capabilities.

### CROSS REFERENCE TO RELATED APPLICATIONS

This application claims priority from U.S. Provisional Patent Application No. 60/556,902 filed on Mar. 29, 2004, the entire disclosure of which is incorporated herein by reference.

### BACKGROUND OF THE INVENTION

1. Technical Field

The invention relates generally to monitoring and modeling systems. More particularly, the invention relates to a method and apparatus for modeling and detecting abnormal behavior in the execution of enterprise software.

2. Discussion of the Prior Art

Web services or the use of service oriented architecture (SOA) to integrate applications, are being adopted by the information technology (IT) industry for many reasons. The integrated applications are commonly referred to hereinafter as “enterprise software applications” (ESAs). Typically, an ESA includes multiple services connected through standards-based interfaces. An example of an ESA is a car rental application that may include a website that allows a customer to make vehicle reservations through the Internet; a partner system, such as airlines, hotels, and travel agents' and legacy systems, such as accounting and inventory applications. The successful operation of an ESA depends on properly serving the customers requests in a timely manner. Typically, an ESA often needs to run 24/7, i.e. twenty four hours a day and every day of the year. For this reason, there is an on-going challenge to develop effective techniques for reliable detection of abnormal behavior, and for providing alerts when irregular behavior is detected.

In the related art, a few monitoring systems, capable of detecting and forecasting abnormal behavior of monitored applications (or systems), are disclosed. Specifically, a typical monitoring system uses historical data to analyze and detect normal usage patterns of the monitored application. Based on the normal usage patterns one or more predictive functions for the normal operation are generated. The monitoring system is then set according to the predictive function with alarm thresholds that track the expected normal operational pattern.

One example of a monitoring system is provided in U.S. patent application Ser. No. 10/324,641, by Helsper, et al. which is incorporate herein for description of the background. Helsper teaches a monitoring system, including a baseline model, that automatically captures and models normal system behavior. Hesper further teaches a correlation model that employs multivariate auto-regression analysis to detect and forecast abnormal system behavior. The baseline model decomposes input variables modeled by a global trend component, a cyclical component, and a seasonal component. Modeling and continually updating these components separately permits a more accurate identification of the erratic component of the input variable, which typically reflects abnormal patterns when they occur. The monitoring system further includes an alarm mechanism that weighs and scores a variety of alerts to determine an alarm status and implement appropriate response actions.

Another monitoring system is disclosed in U.S. patent application Ser. No. 09/811,163 by Helsper, et al. which is incorporated herein for its description of the background. Helsper provides a method that forecasts the performance of a monitored system to prevent failures or slow response time of the monitor system proactively. The system is adapted to obtain measured input values from a plurality of internal and external data sources to predict a system's performance, especially under unpredictable and dramatically changing traffic levels. This is done in an effort to proactively manage the system to avert system malfunction or slowdown. The performance forecasting system can include both intrinsic and extrinsic variables as predictive inputs. Intrinsic variables include measurements of the system's own performance, such as component activity levels and system response time. Extrinsic variables include other factors, such as the time and date, whether an advertising campaign is underway, and other demographic factors that may effect or coincide with increased network traffic.

A major drawback of prior art monitoring systems, and especially the system disclosed by Helsper, is the disability to build a representative usage profile of ESAs. One of many reasons for this drawback is the complex structure and the diverse nature of such applications. These functions can be highly sparse, highly dense, may or may not have a weekly or daily usage pattern, may or may not have influence of special external events. Additionally, new functions can be added every day but their nature is only gradually revealed.

The existing monitoring systems fail in monitoring input variables such as throughput, availability, and response time of the individual service and error functions included in the ESAs. Furthermore, prior art solutions use a single baseline model to modulate the application's behavior. In an ESA that includes multiple service functions, each function behaves differently, and therefore utilizing a single model on all functions is error prone.

It would be, therefore, advantageous to provide a solution for early detection of abnormal behavior of service functions in ESAs by analyzing the nature behavior of each service or error function integrated in an ESA.

### BRIEF DESCRIPTION OF THE DRAWINGS

FIG. 1 is a flowchart describing the method and apparatus for creating a profile using the throughput measured for a service function in accordance with one embodiment of invention;

FIG. 2 is a flowchart describing the execution of the correlation procedure in accordance with one embodiment of the invention;

FIG. 3 is an example of a daily vector;

FIG. 4 is an example of a correlation matrix;

FIG. 5 is a flowchart describing the execution of step in accordance with an exemplary embodiment of the invention;

FIG. 6 is flowchart describing the execution of step where a HFA profile is created in accordance with an embodiment of the invention;

FIG. 7 is a graph representation of the expected daily activity for a service function;

FIG. 8 is a flowchart describing the execution of the forecasting procedure in accordance with an exemplary embodiment of the invention;

FIG. 9 is a flowchart describing the grading process of throughput profiles in accordance with one embodiment of the invention;

FIG. 10 is a flowchart describing the procedure for calculating a response time profile in accordance with one embodiment of the invention; and

FIG. 11 is a block diagram of a system for detecting abnormal behavior of enterprise software applications in accordance with one embodiment of the invention.

### DETAILED DESCRIPTION OF THE INVENTION

According to the invention method and apparatus three different data types are collected and analyzed for each service function, including, but not limited to, throughput, response time, and non-availability. The throughput is measured as the number of calls to a function in a time period; the non-availability is the number of failed calls to a function in a time period; and response time is the time that it takes a function to respond to a call. For each data type, a different type of profile is created to represent the function's behavior accurately. All profiles, regardless of their type, are created using historical data aggregated in a predetermined time period, e.g. one month and are referred to hereinafter as the considered history.

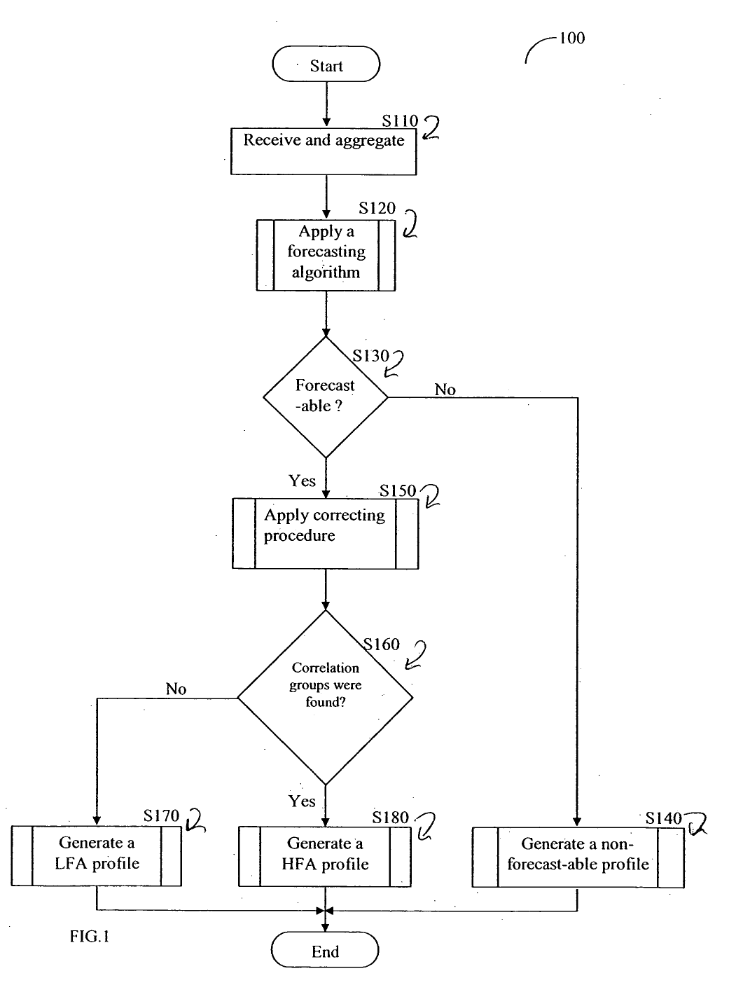

Referring now to FIG. 1, a non-limiting and exemplary flowchart 100, describing method and apparatus for creating a profile using the throughput measured for a service function in accordance with one embodiment of invention is shown. The invention determines the type of throughput profile that best represents the behavior of the monitored function according to the input data. The input data include the number of function calls in a predefined time. There are at least three different types of throughput profiles: a) non-forecast-able function profile; b) forecast-able low frequency activity (LFA) function profile; and c) forecast-able high frequency activity (HFA) function profile. The non-forecast-able profile allows determining whether a present activity is probable according to the considered history; the LFA profile allows to predict the daily activity and the activity bound for every time bucket within that day accurately; the HFA provides an accurate forecast of an internal daily distribution.

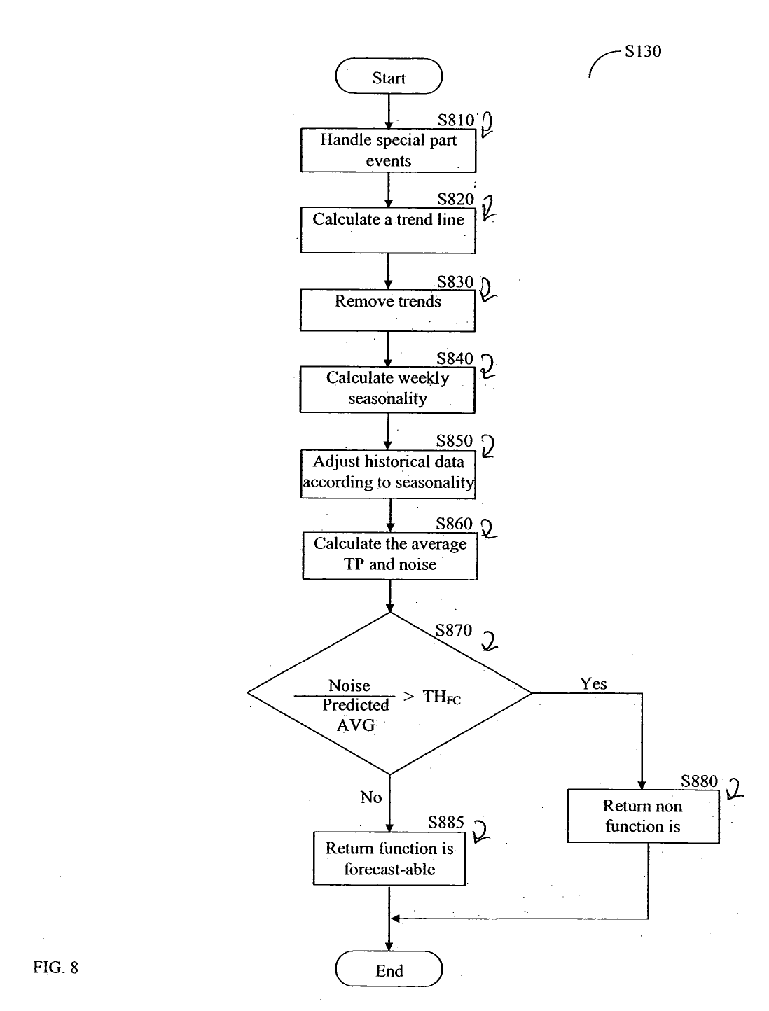

At step S110, the number of calls for a service function, aggregated in time buckets, is received. A time bucket defines a minimum time resolution to aggregate data, for example, a time bucket may be a period of one minute. At step S120, a forecasting procedure is applied to determine if the throughput in the future can be predicted. The forecasting procedure divides the considered history to two parts: history past and history future. The history past is used for computing the throughput in the history future and compares it to the actual history future. If a match exists e.g. the mean square error (MSE) to signal average ratio is low, then the function is considered as being forecast-able. The forecasting procedure is described in greater detail below with reference to FIG. 8. At step S130, based on the input provided by the forecasting procedure, it is checked whether the service function is forecast-able. For non forecast-able functions execution continues with step S140, where a non forecast-able profile is created. For forecast-able functions execution continues with step S150 where a correlation procedure is applied.

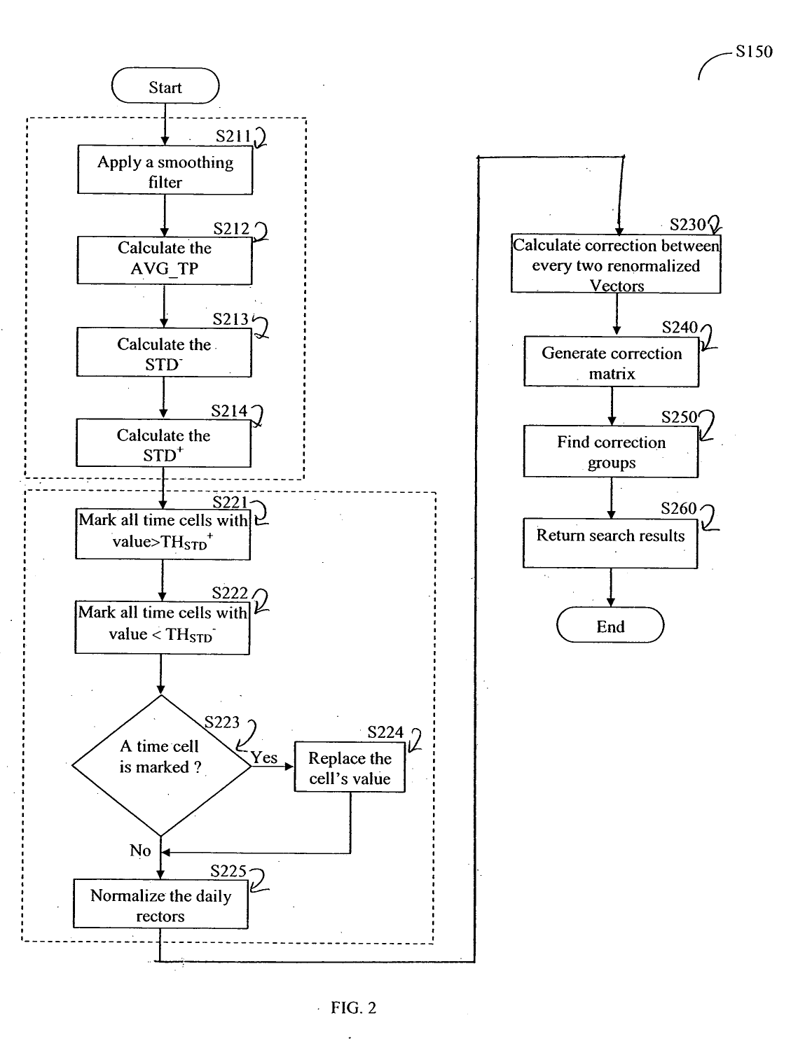

Referring now to FIG. 2, an exemplary and non-limiting flowchart describing the execution of the correlation procedure S150, in accordance with one embodiment of the invention is shown. The correlation procedure identifies and groups days in which the daily activity distribution of the function is similar. For example, one correlation group may include weekends, and another group may include the rest of the week. Namely, the procedure returns one or more correlation groups if such groups are found; otherwise, the procedure returns a null value.

At steps S211 through S214, the considered history is pre-processed. The activity in each day is maintained in a daily vector that includes a plurality of time cells. The number of time cells is determined according the cell's resolution, which is a preconfigured time period, e.g. ten minutes. Each time cell includes the percentage of calls relative to the total number of calls in the day. At step S211, a smoothing filter is applied on every daily vector to reduce the effect of arbitrary values. In one embodiment, the filtering function used by the smoothing filter may be:
F(xₜ)=F₁xₜ₋₁+F₁xₜ+F₁xₜ+F₁xₜ₊₁ (1)
where, the values xₜ₋₁, xₜ, and xₜ₊₁ are number of calls in time cells t−1, t, and t+1 respectively. The sum of the coefficients F₁, F₂, and F₃ is always 1.

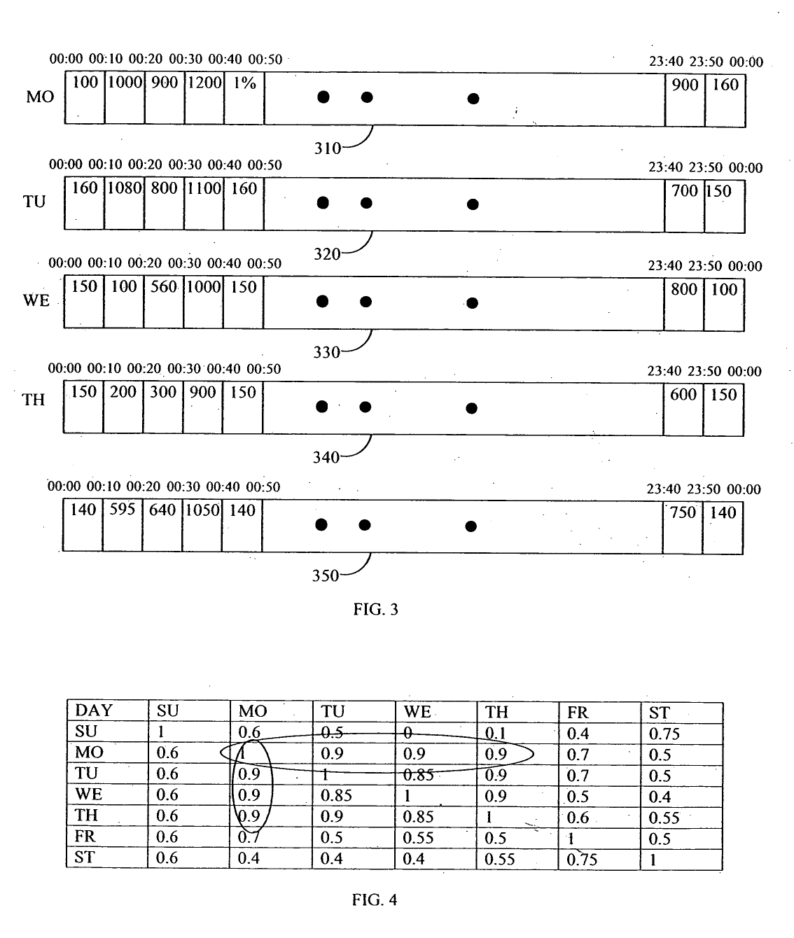

At step S212, for every time cell the average throughput “AVG_TP” of the total days in the considered history is calculated. The result is an interim group profile which defines a daily vector with the respective AVG_TP value computed for the time cell. An example provided by FIG. 3 shows four daily vectors 310 through 340 that are part of the considered history. Vectors 310, 320, 330, and 340 represent the activity measured in Monday, Tuesday, Wednesday, and Thursday respectively. A time cell in each vector is of a ten minutes resolution, i.e. includes the number of calls measured during ten minutes of a respective part of the day. For instance, time cell 00:00-00:10 of vector 310 includes the number 100, i.e. 100 function calls were received between 00:00 and 00:10. Daily vector 350 is the computed interim group profile is a daily vector 350. The time cell 00:00 to 00:10, in vector 350, includes the AVG_TP value 140 which is the average of time cells 00:00 to 00:10 of vectors 310 through 340. The same is true for the rest of the vectors shown in FIG. 3. At step S213, for each time cell in the interim group profile, e.g. vector 350, the negative standard deviation “STD⁻” of each time cell is calculated for values in the considered history that are lower than the value of AVG_TP. At step S214 the positive standard deviation “STD⁺” of each time cell is calculated using values in the considered history that are higher than the value of AVG_TP. The standard deviation may be computed using the equation:

$$STD = \frac{1}{N} \sqrt{{\sum }_{i = 1}^{N} {( {x}_{i} - \overline{x} )}^{2}} \qquad ( 2 )$$

where xᵢ are time cell values and x⁻ is the AVG_TP.

STD⁺ and STD⁻ are the positive and negative, partial non symmetric standard deviations. Specifically, STD⁺ includes only the xᵢ values that greater than AVG_TP, and N is the number of these elements. Accordingly, the STD⁻ includes only the xᵢ values that are lower than or equal to the AVG_TP, and N is the number of those elements.

At steps S221 through S225, an iterative refinement process that removes suspected and special events is performed. Specifically, at step S221, each time cell in the daily vectors with a value greater than the threshold TH_{STD}⁺ is identified and marked. The threshold TH_{STD}⁺ is defined as:
TH_{STD}⁺=AVG_{—}TP+P*STD⁺ (3)

The coefficient P is a configurable parameter and in one embodiment of the disclosed invention may vary between two and three. At step S222, each time cell in the daily vectors with a value lower than the threshold TH_{STD}⁻ is identified and marked. The threshold TH_{STD}⁻ is defined as:
TH_{STD}⁻=AVG_{—}TP−S*STD⁻ (4)

The coefficient S is a configurable parameter and in one embodiment of the disclosed invention may vary between two and three.

At step S223 it is determined if at least one time cell having a peak value was identified at steps S221 or S222 and, if so, execution continues with S224; otherwise, execution continues with step S225. At step S224, for each daily vector that includes a marked time cell, i.e. a cell with a peak value, the time cell's value is replaced with a relative new value. The new value is equal to the value of the respective time cell in the interim group profile, e.g. vector 350 multiplied by the total number of calls in the daily vector. For example, the time cell 00:10-00:20 on Monday includes a value that is lower than TH_{STD}⁻, the value in this time cell is replaced with the value 0.4*4000=1600, where 0.4 is the relative AVG_TP, i.e. the AVG_TP of the cell divided by the total number of calls, of time cell 00:10-00:20 of vector 350 and 4000 is total number of calls on Monday. At step S225 each of the daily vectors is normalized to the total sum of 1. This is performed by dividing the content of a time cell with the total number of calls for that day (if different from 0). Namely, a time cell in a daily vector represents the percentage of expected daily activity within that time cell.

At step S230, the correlation between two normalized vectors in the considered history is calculated. The result is a value between 1 and −1, where 1 indicates that the vectors are fully correlated, while −1 indicates that the vectors are fully negatively-correlated, and zero indicates that they are fully non-correlated. At step S240, a correlation matrix that includes all values calculated at step S230 is generated. An example for a correlation matrix is provided in FIG. 4. At step S250, correlation groups are found by searching the correlation matrix. Correlation groups are all indices having value greater than a preconfigured value, e.g. 0.8. The matrix shown in FIG. 1 includes a correlation group of the days Monday, Tuesday, Wednesday, and Thursday. At step S260, the search results are returned. Specifically, if the search cannot find full week coverage using the correlation criterion in any aggregation a null value is returned. Full week coverage implies that at least all week days are correlated with each other, i.e. Sundays with Sundays, Mondays with Mondays, and so on. In another embodiment, if only part of the weekdays are correlated, e.g. Monday-Thursdays, and part are not correlated, e.g. Fridays-Sundays a composite profile, with HFA behavior for the correlated days and LFA behavior for non correlated days may also be created.

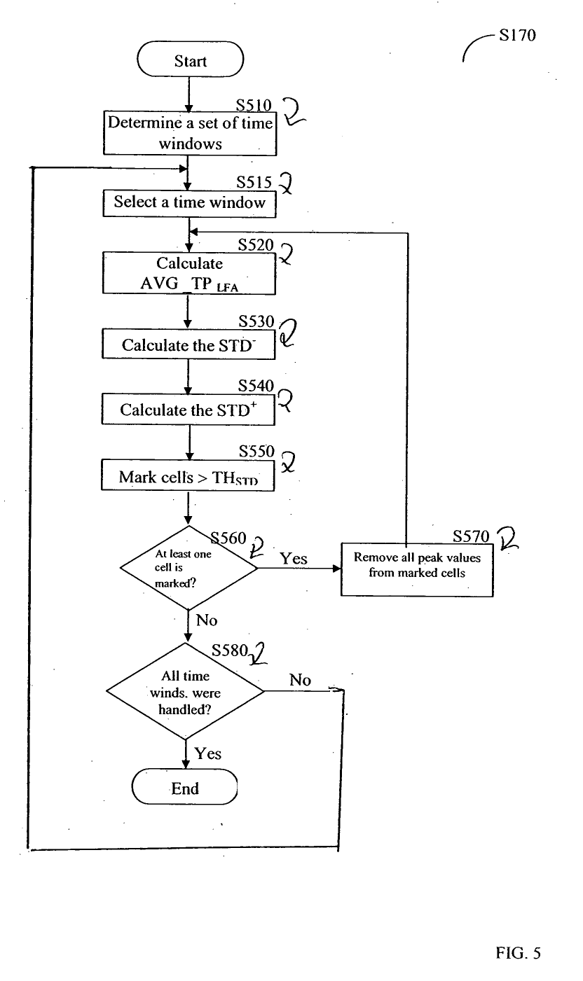

Reference is made to FIG. 1, where at step S150 it is determined the type of the profile to be generated. Specifically, if at least one correlation group is found, then at step S180 an HFA profile is created for the service function; otherwise, if a null value is returned, execution proceeds with step S170 where an LFA profile is created as shown in FIG. 5.

Referring now to FIG. 5, a non-limiting and exemplary flowchart describing the execution of step S170, in accordance with an exemplary embodiment of the present invention, is shown. An LFA profile is produced for a service function without internal correlated daily distribution. For that purpose, data aggregated in several time windows are analyzed. Each of the time windows represents the number of function calls in a specific time period of the day. For example, the time windows may be of one minute, ten minutes, 30 minutes, and 60 minutes. The one minute time window may include the number of calls measured during 21:00-21:01, the ten minutes time window may include the number of calls measured during 21:00-21:10, and so on.

At step S510, a set of time windows for data in the considered history is determined. At step S515, a time window j is selected. Each time execution reaches this step a different time window is chosen. The time windows are sliding windows, i.e., there is an overlap between two consecutive sets of time windows. At step S520, an average LFA throughput “AVG_TP_{LFA}” is calculated for time window j. The AVG_TP_{LFA} is calculated using the considered history and the content of the time window j. At step S530, the negative standard deviation STD⁻ is calculated using the values in the considered history that are lower than the value of AVG_TP_{LFA}. At step S540 the positive standard deviation STD⁺ is calculated using values in the considered history that are higher than the value of AVG_TP_{LFA}. At step S550, all peak values in the considered history that are greater than the threshold TH_{STD} are identified and marked. The threshold TH_{STD} is defined as:
TH_{STD}=AVG_{—}TP_{LFA}+K*STD⁺ (5)

The coefficient K is a configurable parameter and may, in one embodiment of the disclosed invention, vary between two and three.

At step S560, it is determined if at least one peak value was identified at S550 and, if so, execution proceeds with step S570; otherwise, execution continues with step S580. In an embodiment of the invention the process for identifying peak values can be executed a predefined number of times. At step S570 all marked peak values are removed from the considered history and execution returns to step S520 where the values AVG_TP_{LFA}, STD⁺ and STD⁻ are re-calculated. At step S580, a check is made to determine if all time windows determined at step S510 were handled and, if so, execution terminates; otherwise, execution returns to step S515 where another time window is selected. The resultant LFA profile contains the expected daily throughput (AVG_TP_{LFA}) and the upper bound (STD⁺) and a lower bound (STD⁻) for that expectancy computed for each window time. It should be noted that the steps of method S170 described hereinabove may be performed in order or in parallel.

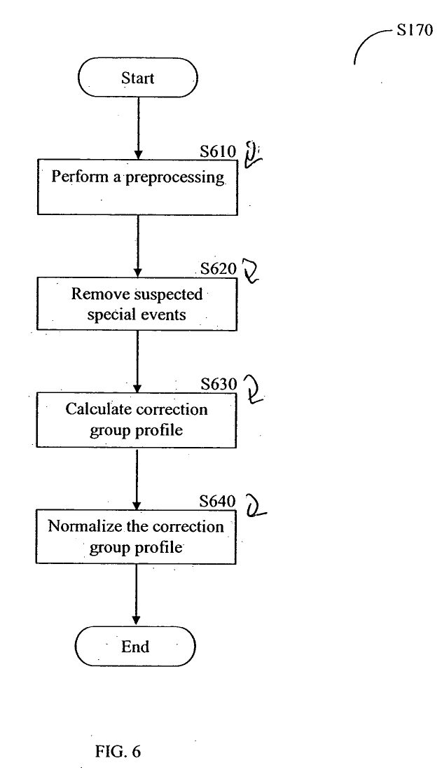

Reference is made to FIG. 1 where at step S140 the procedure for creating a non forecast-able profile is created. The non forecast-able profile allows one to determine if the current activity was observed or is probable in the considered history. The non-forecast-able profile may be created using the procedure for generating an LFA profile described in greater detail above. At step S180 an HFA profile is created as shown in FIG. 6.

Referring to FIG. 6, a non-limiting and exemplary flowchart describing the execution of step S180, where an HFA profile is created in accordance with an embodiment of the invention, is shown. An HFA profile is created for each correlation group found in step S150. The HFA comprises the internal daily activity distribution data. The distribution data is a daily vector that represents the percentage of expected daily activity within each time cell. The procedure processes aggregated data as received at step S110. These data may be saved at a temporary storage location and retrieved whenever the HFA creation procedure is executed.

At step S610, a sub-procedure for preprocessing the considered history is applied. The preprocessing comprises: a) filtering the data to reflect the arbitrariness and completeness and b) computing the average throughput AVG_TP, STD⁺, and STD⁻. The preprocessing is described above in greater detail at steps S211 through S214. The result of step S610 is a total group profile, which is a daily vector that includes, for each time cell, AVG_TP, STD⁺ and STD⁻.

At step S620, a process for removing suspected special events is performed. The process includes the activities of: a) marking all time cells having values greater than TH_{STD}⁺ or values lower than TH_{STD}⁻; b) substituting each peak value with a relative value; and c) normalizing each daily vector to the sum of 1. The process for removing suspected special events is described in detail for steps S221 through S225 above.

At step S630, a correlation group profile is calculated for each correlation group found in step S150. This includes re-calculating the AVG_TH, STD⁺ and STD⁻ values in the total group profile using the new daily vectors generated at step S620. At step S640, each correlation group profile, i.e. each daily vector is normalized to the sum of 1, and thereby producing normalized time cells representing the percentage of expected daily activity within the cell. The new STD⁺ and STD⁻ values are used to determine the upper and lower bounds of each time cell.

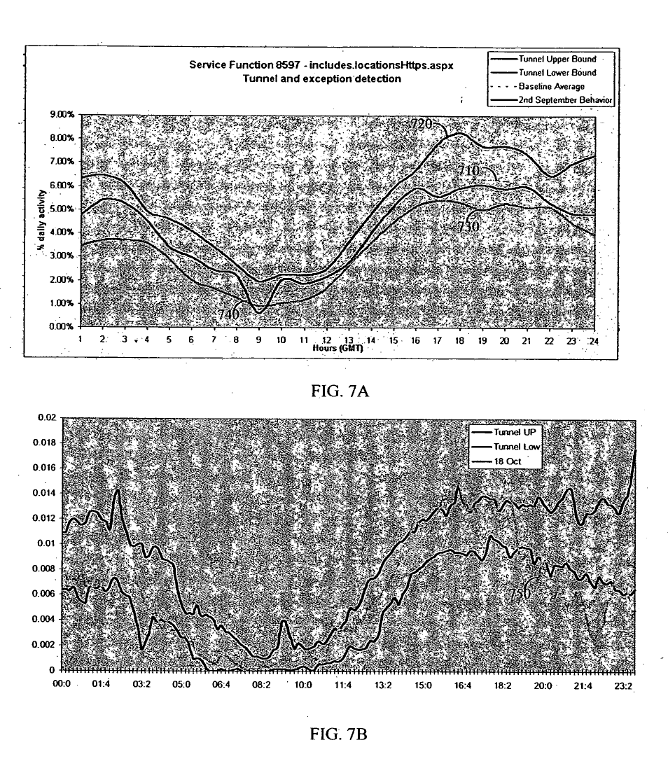

FIG. 7A depicts an exemplary and non-limiting graph representing the expected daily activity for a service function. Line 710 is the profile baseline, i.e. the expected throughput and lines 720 and 730 are the upper and lower bounds respectively. The resolution in which the data is presented is one hour. As can be noted, exceptional behavior detected by lower bound violation at approximately 9:00 am. FIG. 7B depicts an exemplary and non-limiting graph representing the expected daily activity in a resolution of ten minutes. As can be seen, the observed activity, line 750, is nosier. However, the upper and lower bounds are adjusted to capture the noise. Here, an exceptional behavior is detected by an increased activity and a lower bound violation.

The procedure described herein for creating a throughput profile adaptively produces a service function's profile according to the observed activity. That is, the type of a profile created for a function can be replaced with a new type of profile as the behavior of the function is changed. For example, if for a service function a low activity is observed, then an LFA profile is generated. However, if there is a sharp increase in the activity an HFA profile is generated and replace the LFA profile.

Referring to FIG. 8, a non-limiting and exemplary flowchart S120 describing the execution of the forecasting procedure in accordance with an exemplary embodiment of the invention is shown. The forecasting procedure determines if a total daily throughput can be predicted based on the historical throughput data. To forecast the throughput an assumption is made that the total daily activity in the considered history is accurate. Furthermore, to correctly predict the throughput variables, effects such as seasonality, trends, and special events are taken into account.

At step S810, special past events are handled by searching in the considered history parts of the days in which the behavior is exceptional, and replacing the throughput, i.e. number of function calls in these days, with the average throughput in similar days. Special past events may be also events marked by the user, e.g. holidays, promotions, and so on. At step S820, a trend line that shows a general tendency of activity is calculated by fitting a linear regression line to the historical data. At step S830, trends in the considered history are removed by dividing the past data with the trend line computed in step S820. At step S840, the weekly seasonality is calculated using the trend-less past data. The throughput of service functions is a result of users' activities, and therefore there is a strong daily seasonality pattern within the week and daily distribution according to days of the week. To calculate the weekly seasonality, the average throughput and standard deviation STD for every week day is computed. The seasonality curve is then determined using non-linear stochastic or a curve fitting procedure. The seasonality curve and trend line are calculated using notations that are well known to a person skilled in the art and may be found in Chapter 15 of Numerical Recipes in C which is incorporated herein for its description. At step S850, the historical data are adjusted with the seasonality curve found at S840 to remove the seasonality effects from past data. At step S860, the average predicted throughput and the estimated noise magnitude are calculated. The average predicted may be a constant value, as the external effects, e.g. special events, seasonality, and trends, have been removed. The noise magnitude is determined as the mean absolute deviation (MAD) or mean square error (MSE). At step S870, a check is made to determine if the ratio of the noise magnitude and predicted average, i.e. noise magnitude/predicted average, is greater than a preconfigured threshold TH_{FC}. If this is found to be the case, the service function is determined as non-forecast-able; otherwise, it is determined as forecast-able.

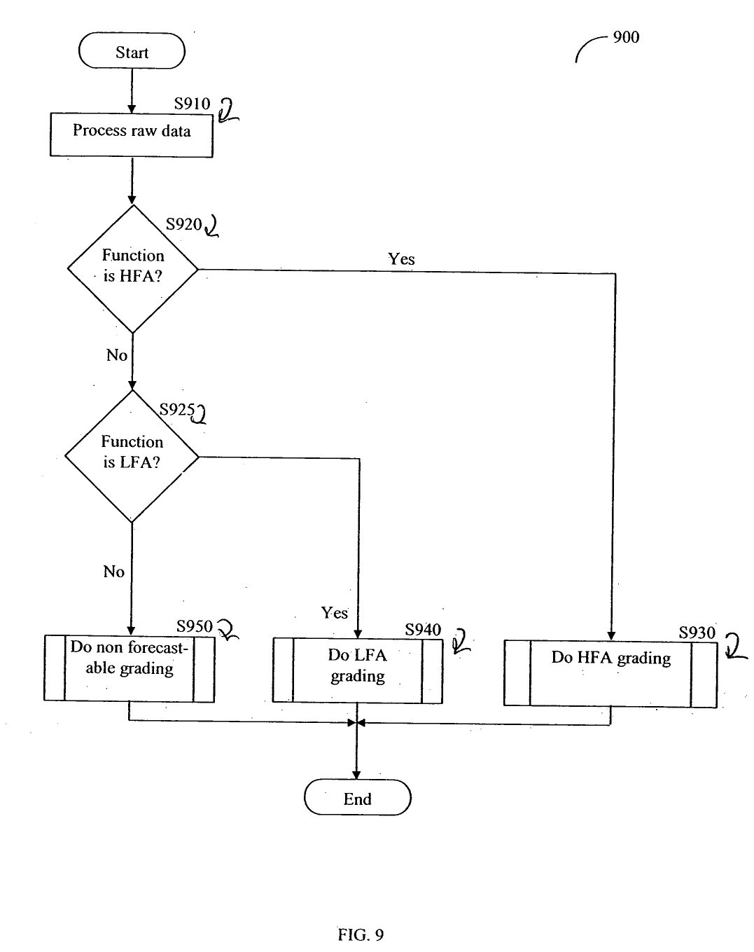

Referring to FIG. 9, a non-limiting and exemplary flowchart 900 describing the grading process of throughput profiles, in accordance with one embodiment of the invention is shown. The grading process determines whether a continuously measured throughput of a service function represents a normal or exceptional behavior. The decision is based upon the tunnel bounds, severity of bound violation, time of violation, user inputs, and so on. The grading process processes input data to ensure completeness and consistency of the data with the generated profile. Each service function is graded according to the profile type of the function.

At step S910, raw data are received and processed as long as the monitored service function is active. At steps S920 and S925, a check is performed to determine the type of profile associated with the monitored function. Specifically, at step S920 it is checked if the function is associated with an HFA profile and, if so, execution proceeds with step S930; otherwise, another check is made to determine whether the function is related to an LFA profile and, if so, execution continues with step S940. If the function is identified as a non forecast-able function, execution continues with step S950.

At step S930, an HFA grading is performed. HFA functions are graded on fixed time cells in the daily profile. Specifically, a grading of a time cell tᵢ₋₁, is done when a time cell tᵢ is received. Prior to grading a time cell tᵢ₋₁, a smoothing Gaussian filter is applied on three consecutive time cells, i.e. tᵢ₋₂, t ᵢ₋₁, and tᵢ using the smoothing function described in greater detail above.

The total counts of function calls for a time cell are constantly measured against the upper and lower bounds to find whether constraints are violated. The tunnel bounds are set as follows: a) executing the forecasting procedure to calculate the expected daily activity forecast; and b) multiplying the profile's bounds by the expected daily activity forecast. The profile's bounds are the upper and lower bounds for a time cell as determined by the profile of the function. The accuracy of the forecasting procedure may be also used to widen or narrow the tunnel bounds, i.e. high accurate forecast yields a narrow tunnel bounds.

At step S940 an LFA grading is preformed. LFA functions are graded on sliding time windows. The total counts of function calls in a time window are constantly measured against the upper and lower bounds to find if constraints are violated. The tunnel bounds are adjusted by the expected total daily throughput value provided by the forecast. Specifically, the tunnel bounds are adjusted as follows: a) executing the forecasting procedure to forecast the total daily throughput; and b) computing the tunnel's new value according to:

$$new\_value = current\_value \times \frac{forecast daily throughput}{profile average daily throughput} \qquad ( 6 )$$

The current value is as determined by the profile.

At step S950, a grading of non forecast-able functions is performed. Here, as for LFA functions as well, grading is done on sliding windows. The total number of function calls in a time window is constantly measured against the upper and lower bounds. However, the upper and lower bounds of a non forecast-able function are fixed to the values set by the function's profile.

In one embodiment of the invention a profile is generated for a service function based on average response time measurements. The average response is calculated as the total response time per minute divided by the number of function calls per minute.

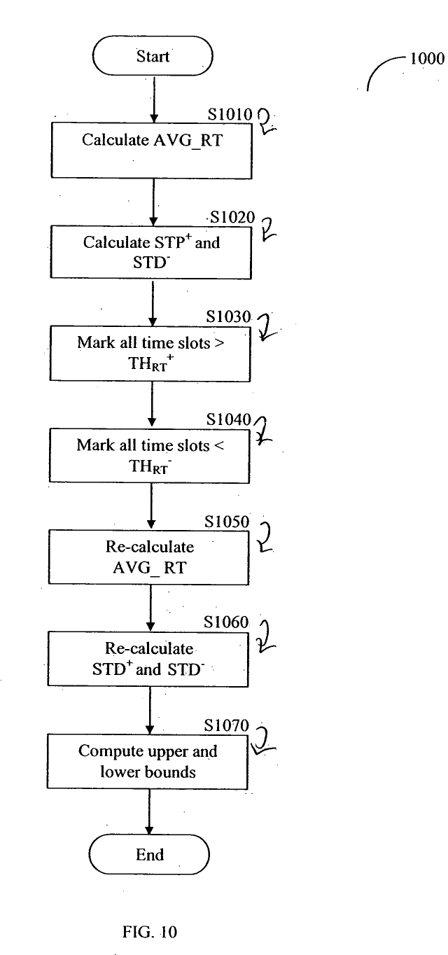

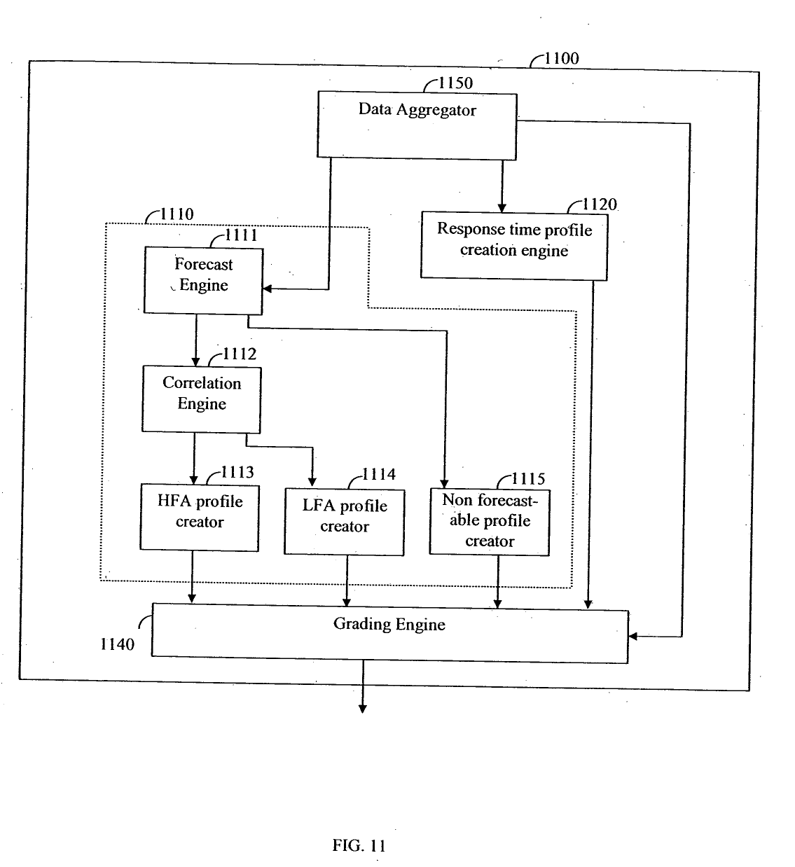

Referring now to FIG. 10, a non-limiting and exemplary flowchart 1000 describing the procedure for calculating a response time profile is shown. The procedure calculates a typical response time per function and the acceptable bounds. It should be noted by a person skilled in the art that a response time may be changed drastically due to circumstances which are not quantifiable, such as system reboot, backup routine operations, power spikes, start of another application on the same server, and so on. On the other hand, error responses in which the function immediately responds, creates an artificial quick function response time.

To remove peaks and lows at step S1010 the average response time “AVG_RT” per a function call is calculated using the considered history. At step S1020, the positive and negative standard deviation STD⁺ and STD⁻ are calculated. At step S1030, all time slots with AVG_RT greater than the threshold TH_{RT}⁺ are marked. The threshold TH_{RT}⁺ is defined as follows:
TH_{RT}⁺=AVG_{—}RT+B*STD⁺ (7)

The coefficient B is a configurable parameter that may vary between two and three. At step S1030 all time slots with AVG_RT lower than the threshold TH_{RT}⁻ are marked. The threshold TH_{RT}⁻ is defined as follows:
TH_{RT}⁻=AVG_{—}RT−B*STD⁻ (8)

At step S1040, the AVG_RT value per a function call is recalculated without using time slots marked at steps S1020 and S1030. At step S1050 STD+ and STD⁻ are calculated using the new AVG_RT value, while ignoring time slots marked at S1020 and S1030. At step S0160, the profile lower and upper bounds as set as follows:
Lower-bound=maximum [0.25*AVG_{—}RT, AVG_{—}RT−A*STD⁻]; (9) and
Upper-bound=AVG_{—}RT+A·STD⁺ (10)

The grading of a response time profile is performed on a sliding time window of a predefined number of time slots. For example, if a time slot is a one minute, grading may be performed on a ten minutes time window. As peaks and lows are of different nature, their values cannot be averaged. Therefore, inside a time window, the number of time slots violating upper bound constraints and the number of time slots violating upper bound constraints are separately counted. An exception is generated if at least one of the following conditions is violated: a) a number of upper bound violations is greater than a first threshold TH₁; b) a number of lower bound violation is greater than a second threshold TH₂; or c) a number of lower bound violations plus the upper bound violations is greater than a third threshold TH₃. In one embodiment of the disclosed invention the thresholds TH₁, TH₂, TH₃ may be set to 0.3 times the number of time slots in the sliding time window.

Referring now to FIG. 11 a non-limiting and exemplary block diagram 1100 of a system for detecting abnormal behavior of enterprise software applications in accordance with one embodiment of the invention is shown. The system 1100 may comprise a throughput profile creation engine 1110, a response time profile creation engine 1120, a grading engine 1140, and a data aggregator 1150. The Data aggregator 1150 classifies that incoming data of a respective service function into throughput, response time, and non availability measures, and it further aggregates these measures into pre-configured time aggregation windows. The engine 1110 executes all activities related to creating a profile for a throughput measurement as described in greater detail above. The engine 1110 may comprise a forecast engine 1111 for predicting the daily through activity, a correlation engine 1112 for generating correlation groups of days with a similar activity, an HFA profile creator 1113 for creating an HFA profile for each correlation group found be correlation engine 1112, an LFA profile creator 1114 for creating an LFA profile, and a non forecast-able profile creator 1115 for creating profiles for those functions determined by forecast engine 1111 as being not forecast-able. The engine 1120 executes all activities related to generating profile using the response time measurements as described in greater detail above. A grading engine 1140 applies the grading process according to the profile type, i.e. HFA, LFA, non forecast-able, and response time. Specifically, the grading engine 1140 sets the upper and lowers bounds constraints for a function, processes incoming data, and generates an exception if one of the constraints is violated.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A method for detecting abnormal behavior of a plurality of service functions integrated in an enterprise software application, said method comprising the steps of:
collecting data of a plurality of data types and for said plurality of service functions integrated in said enterprise software application;
analyzing said collected data;
classifying each of said service functions to a plurality of behavior types based on historical data of said service functions; and
adaptively creating for each behavior type and each data type a corresponding behavior profile for said service functions using said collected data.

2. The method of claim 1, wherein each of said service functions further comprises at least a monitored entity.

3. The method of claim 2, wherein said monitored entity comprising any one of: an error function, a system parameter, an error code, and a combination thereof.

4. The method of claim 1, wherein said data type comprises any of throughput, response time, and non-availability.

5. The method of claim 4, wherein said behavior profile for a throughput data type comprises any of an expected number of calls to said service function in a time period, an upper tunnel bound, and a lower tunnel bound.

6. The method of claim 4, wherein said behavior profile for a response time data type comprises any of an expected average response time of said response time an upper expectancy tunnel bound and a lower tunnel bound.

7. The method of claim 5, wherein said step of creating a throughput behavior profile comprises the steps of:
determining if said service function is one of a forecast-able service function, and a non-forecast-able function; and
determining if said forecast-able service function is one of a correlated service function and a non-correlated service function.

8. The method of claim 7, wherein the step of determining if said service function is said forecast-able service function is performed using a forecasting procedure.

9. The method of claim 7, wherein the step of determining if said service function is said correlated service function is performed using a correlation procedure.

10. The method of claim 9, wherein said correlation procedure generates for said correlated service function a list of correlation groups, wherein each of said correlation groups comprises days having a similar daily activity distribution.

11. The method of claim 9, wherein said step of creating said behavior profile of said correlated service function comprises the step of generating a high frequency activity (HFA) profile for each of said correlation groups.

12. The method of claim 11, wherein the step of creating said HFA profile comprises the steps of:
pre-processing said collected data;
removing suspected special events in said collected historical data; and
calculating a correlation group profile.

13. The method of claim 12, wherein said correlation group profile comprises a daily vector, and wherein said daily vector comprises a plurality of time cells.

14. The method of claim 13, wherein each of said time cells comprises any of an average percentage of calls relative to a total number of calls in a day, an upper tunnel bound, and a lower tunnel bound.

15. The method of claim 9, wherein the step of creating said behavior profile of said non-correlated service function comprises the step of generating a low frequency activity (LFA) profile.

16. The method of claim 15, wherein said step of generating said LFA profile comprises the steps of:
for each time window, calculating any of an average number of calls in said time window, an upper tunnel bound, and a lower upper tunnel bound;
removing suspected special events in said time window; and
for each time window, recalculating any of said calculated average number of calls in said time window, said upper tunnel bound, and said lower upper tunnel bound.

17. The method of claim 16, wherein said upper tunnel bound is set to a value of a configurable parameter multiplied by a positive standard deviation plus an average throughput.

18. The method of claim 17, wherein said lower tunnel bound is set to a value of a configurable parameter multiplied by a negative standard deviation plus an average throughput.

19. The method of claim 7, wherein the step of creating said behavior profile for a non-forecast-able service function comprises the steps of:
for each time window, calculating any of an average number of calls in said time window, an upper tunnel bound, and a lower upper tunnel bound;
removing suspected special events in said time window; and
for each time window, recalculating any of said calculated average number of calls in said time window, said upper tunnel bound, and said lower upper tunnel bound.

20. The method of claim 7, further comprising the step of:
grading throughput data to determine whether a continuously measured throughput of said service function represents at least one of a normal behavior and an exceptional behavior.

21. The method of claim 20, wherein the step of grading the HFA data comprises for each time cell in the daily vector the steps of:
forecasting an expected daily activity;
adjusting said upper bound tunnel and said lower bound tunnel according to said expected daily activity;
filtering said measured throughput in a time cell; and
generating an exception if at least one of said upper bound tunnel and said lower bound tunnel is violated.

22. The method of claim 20, wherein the step of grading of the LFA data is performed on sliding windows.

23. The method of claim 22, wherein the step of grading said LFA data comprises for each time window the steps of:
forecasting an expected daily activity;
adjusting said upper bound tunnel and said lower bound tunnel according to said expected daily activity; and
generating an exception if at least one of said upper bound tunnel and said lower bound tunnel is violated.

24. The method of claim 20, wherein the step of grading a non forecast-able data comprises the steps of:
comparing said measured throughput in each time window against said upper tunnel bound and said lower tunnel bound; and
generating an exception if at least one of said upper bound tunnel and said lower bound tunnel is violated.

25. The method of claim 6, the step creating a response time behavior profile comprising the steps of:
for each service function call calculating any of an average response time, an upper tunnel bound, and lower upper tunnel bound;
removing suspected special events in said aggregated data; and
for each time window recalculating any of said calculated average response time, said upper tunnel bound, and said lower upper tunnel bound.

26. The method of claim 25, further comprising the step of:
grading response time measured data.

27. The method of claim 25, wherein the step of grading said response time measured data is performed on at least one adaptive size sliding time window, said adaptive size sliding time window contains at least a predefined threshold of active minutes.

28. The method of claim 27, wherein the step of grading said response time measured data comprises the steps of:
counting a number of time slots in said adaptive size sliding time window violating said upper tunnel bound;
counting a number of time slots in said adaptive size sliding time window violating said lower tunnel bound; and
generating an exception if at least one of following conditions is satisfied:
a number of said upper tunnel bound violations is greater than a first threshold;
a number of lower bound violation is greater than a second threshold; and
a number of lower bound violations plus the upper bound violations is greater than a third threshold.

29. The method of claim 1, further comprises the step of:
creating a special behavior profile representing a behavior of said service function in a special time period.

30. A computer software product readable by a machine, tangibly embodying a program of instructions executable by the machine to implement a process for detecting abnormal behavior of plurality of services functions integrated in an enterprise software application, said process comprising the steps of:
collecting data of a plurality of data types and for said plurality of service functions integrated in said enterprise software application;
analyzing said collected data;
classifying each of said service functions to a plurality of behavior types based on historical data of said service functions and
adaptively creating for each behavior type and each data type a corresponding behavior profile for said service functions using said collected data.

31. The computer software product of claim 30, wherein each of said service functions further comprises at least a monitored entity.

32. The computer software product of claim 31, wherein said monitored entity comprises any of an error function, a system parameter, an error code, and a combination thereof.

33. The computer software product of claim 30, wherein said data type comprises any of throughput, response time, and non-availability.

34. The computer software product of claim 33, wherein said behavior profile for a throughput data type comprises any of an expected number of calls to said service function in a time period, an upper tunnel bound, and a lower tunnel bound.

35. The computer software product of claim 33, wherein said behavior profile for a response time data type comprises any of an expected average response time of said response time an upper expectancy tunnel bound, and a lower tunnel bound.

36. The computer software product of claim 34, wherein the step of creating a throughput behavior profile comprises the steps of:
determining if said service function is one of a forecast-able service function and a non-forecast-able function; and
determining if said forecast-able service function is one of a correlated service function and a non-correlated service function.

37. The computer software product of claim 36, wherein the step of determining if said service function is said forecast-able service function is performed using a forecasting procedure.

38. The computer software product of claim 36, wherein the step of determining if said service function is said correlated service function is performed using a correlation procedure.

39. The computer software product of claim 38, wherein said correlation procedure generates for said correlated service function a list of correlation groups, wherein each of said correlation groups comprises days having a similar daily activity distribution.

40. The computer software product of claim 38, wherein the step of creating said behavior profile of said correlated service function comprises the step of generating a high frequency activity (HFA) profile for each of said correlation groups.

41. The computer software product of claim 40, wherein the step of creating said HFA profile comprises the steps of:
pre-processing said collected data;
removing suspected special events in said collected data; and
calculating a correlation group profile.

42. The computer software product of claim 41, wherein said correlation group profile comprises a daily vector, said daily vector comprising a plurality of time cells.

43. The computer software product of claim 42, wherein each of said time cells comprises any of an average percentage of calls relative to a total number of calls in a day, an upper tunnel bound, and a lower tunnel bound.

44. The computer software product of claim 38, wherein the step of creating said behavior profile of said non-correlated service function comprises the step of generating a low frequency activity (LFA) profile.

45. The computer software product of claim 44, wherein the step of generating said LFA profile comprises the steps of:
for each time window, calculating any of an calculated average number of calls in said time window, an upper tunnel bound, and a lower upper tunnel bound;
removing suspected special events in said time window; and
for each time, window recalculating any of said calculated average number of calls in said time window, said upper tunnel bound, and said lower upper tunnel bound.

46. The computer software product of claim 45, wherein said upper tunnel bound is set to a value of a configurable parameter multiplied by a positive standard deviation plus an average throughput.

47. The computer software product of claim 45, wherein said lower tunnel bound is set to value of a configurable parameter multiplied by a negative standard deviation plus an average throughput.

48. The computer software product of claim 36, wherein the step of creating said behavior profile for a non-forecast-able service function comprises the steps of:
for each time window, calculating any of an average number of calls in said time window, an upper tunnel bound, and a lower upper tunnel bound;
removing suspected special events in said time window; and
for each time window, recalculating any of said calculated average number of calls in said time window, said upper tunnel bound, and said lower upper tunnel bound.

49. The computer software product of claim 36, further comprising the step of:
grading throughput data to determine whether a continuously measured throughput of said service function represents any of a normal behavior, and an exceptional behavior.

50. The computer software product of claim 49, wherein the step of grading the HFA data comprises for each time cell in the daily vector the steps of:
forecasting an expected daily activity;
adjusting said upper bound tunnel and said lower bound tunnel according to said expected daily activity;
filtering said measured throughput in said time cell; and
generating an exception if any of said upper bound tunnel and said lower bound tunnel is violated.

51. The computer software product of claim 49, wherein the step of grading of the LFA data is performed on sliding windows.

52. The computer software product of claim 51, wherein the step of grading said LFA data comprises for each time window comprises the steps of:
forecasting an expected daily activity;
adjusting said upper bound tunnel and said lower bound tunnel according to said expected daily activity; and
generating an exception if any of said upper bound tunnel and said lower bound tunnel is violated.

53. The computer software product of claim 49, wherein the step of grading of non-forecast-able data comprises the steps of:
comparing said measured throughput in each time window against said upper tunnel bound and said lower tunnel bound; and
generating an exception if any of said upper bound tunnel and said lower bound tunnel is violated.

54. The computer software product of claim 35, the step of creating a response time behavior profile comprising the steps of:
for each service function call calculating any of an average response time, an upper tunnel bound, and a lower upper tunnel bound;
removing suspected special events in said aggregated data; and
for each time window recalculating, any of said calculated average response time, said upper tunnel bound, and said lower upper tunnel bound.

55. The computer software product of claim 54, further comprising the step of:
grading response time measured data.

56. The computer software product of claim 55, wherein the step of grading said response time measured data is performed on at least one adaptive size sliding time window, wherein said adaptive size sliding time window contains at least a predefined threshold of active minutes.

57. The computer software product of claim 56, wherein the step of grading said response time measured data comprises the steps of:
generating an exception if any of following conditions is satisfied:
counting a number of time slots in said adaptive size sliding time window violating said upper tunnel bound;
counting a number of time slots in said adaptive size sliding time window violating said lower tunnel bound;
a number of said upper tunnel bound violations is greater than a first threshold;
a number of lower bound violation is greater than a second threshold; and
a number of lower bound violations plus the upper bound violations is greater than a third threshold.

58. The computer software product of claim 30, further comprising the step of creating a special behavior profile representing a behavior of said service function in a special time period.

59. An apparatus for detecting abnormal behavior of enterprise software applications, comprising:
a data classifier for classing incoming messages of a respective function according to a data type for data gathered in each of said messages;
a throughput profile creation engine for creating a throughput profile;
a response time profile creation engine for creating a response time profile; and
a grading engine for generating an exception if an expectancy constraint is violated.

60. The system of claim 59, wherein said expectancy constraint is determined by any of said throughput profile and said response-time profile.

61. A method for profiling of a plurality of service functions in an enterprise software application, said method comprising the steps of:
collecting data of a plurality of data types and for said plurality of service functions integrated in said enterprise software application;
analyzing said collected data;
classifying each of said service functions to a plurality of behavior types based on historical data of said service functions; and
adaptively creating for each of said behavior types and each of said data types a corresponding behavior profile for said monitored claims using said collected data.

62. The method of claim 61, wherein each of said behavior types comprises any of a low frequency activity (LFA) behavior, a high frequency activity (HFA) behavior, a forecast-able behavior, and a non-forecast-able behavior.

63. The computer software product of claim 61, wherein said monitored entity comprises any of an error function, a service function, a system parameter, an error code, and a combination thereof.
